(19) United States
(12) Patent Application Publication
(10) Pub. No.: US 2008/0320243 A1
(43) Pub. Date: Dec. 25, 2008

(54) MEMORY-SHARING SYSTEM DEVICE

(75) Inventors: Hirofumi MITSUZUKA, Yokohama (JP); Eiichi Kamata, Yokohama (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/143,374

(22) Filed: Jun. 20, 2008

(30) Foreign Application Priority Data
Jun. 22, 2007 (JP) 2007-165147

(51) Int. Cl. G06F 12/08

(52) U.S. Cl. 711/153; 711/E12.016

(57) ABSTRACT

A memory-sharing system device has a shared memory, divided into forward-direction and backward-direction memory areas; a first processor inputting transfer data in the forward direction, writing the data to the forward-direction memory area, reading transfer data in the backward direction from the backward-direction memory area and outputting the data; and a second processor for transferring data in the back-ward direction. The first or second processor sets memory release criteria for the forward-direction and backward-direction memory areas respectively, and, when the used memory area reaches the memory release criterion, performs memory release processing. The first or second processor monitors the forward-direction and the backward-direction data transfer speed, changes the memory release criterion depending on the data transfer speed.

### CROSS-REFERENCE TO RELATED APPLICATIONS

This application is based upon and claims the benefit of priority from the prior Japanese Patent Application No. 2007-165147, filed on Jun. 22, 2007, the entire contents of which are incorporated herein by reference.

### BACKGROUND

1. Field

The present embodiment relates to a memory-sharing system device, which enables sharing of memory by two processors and transfers data, and in particular relates to a memory-sharing system device with improved efficiency of utilization of shared memory.

2. Description of the Related Art

In recent years, there has been vigorous development of mobile communication terminal devices which perform communication of large volumes of data, such as for example portable telephones and wireless cards. In particular, WiMAX (Worldwide Interoperability for Microwave Access) is one standard for wireless communication technology anticipated as so-called “last mile” connection means, and has also been adopted as a standard for high-speed mobile communication.

Mobile terminals download large amounts of data, such as for example image data, voice data, programs, and similar from base stations, and upload large amounts of data to base stations. In order to enhance performance, two CPUs (processors) are installed within mobile terminals, and by dividing functions between these CPUs, the load on a single CPU is alleviated. In order to reduce costs, the two CPUs share large-scale memory such as SDRAM or flash memory, and data is transferred between the two CPUs via the shared memory.

A MAC (Media Access Control) unit provided within mobile terminals is an example of data transfer via memory shared by two CPUs. This MAC unit has a lower-layer CPU (hereafter, Lower MAC, or LMAC), connected to the wireless device, which mainly performs hardware control, an upper-layer CPU (hereafter, Upper MAC, or UMAC), which performs communication control corresponding to the communication protocol, and shared memory which is shared between these CPUs via a memory controller.

When downloading data, data which has been received via the wireless device is written to shared memory by the lower-layer CPU, and the upper-layer CPU reads this data from shared memory and transfers the data to a upper-level application device. This is called forward-direction data transfer. On the other hand, when uploading data, data from the upper-level application device is written to the shared memory by the upper-layer CPU, and the lower-layer CPU reads the data from the shared memory and transfers the data to the lower-level wireless device. This is called backward-direction data transfer.

This embodiment is not limited to mobile terminals, but also addresses memory-sharing system devices in which two processors share memory, and forward-direction data transfer and backward-direction data transfer between the processors are performed via the shared memory.

A memory-sharing system device separates the shared memory into a forward-direction memory area used for transfer of data in the forward direction, and a backward-direction memory area used for transfer of data in the backward direction, and uses the forward-direction memory area and backward-direction memory area as respective ring buffers during data transfer. That is, in the case of forward-direction data transfer, the lower-layer CPU writes data to the forward-direction memory area and notifies the upper-layer CPU of the writing, and the upper-layer CPU reads the data from the forward-direction memory area. Then, the CPUs end writing and reading and release the memory area, enabling use as a new buffer area. The case of backward-direction data transfer is similar, except that the operations of the lower-layer and upper-layer CPUs are reversed.

In order to transfer large amounts of data at high speed, it is preferable that a memory area serving as a ring buffer be as large as possible. However, the memory capacity of the shared memory is fixed. On the other hand, the transmission speed necessary for forward-direction data transfer and the transmission speed necessary for backward-direction data transfer change dynamically with the circumstances of use of the device. Hence it has been proposed that the boundary between the forward-direction memory area and the backward-direction memory area in shared memory be modified dynamically, and that memory capacities appropriate to usage conditions be allocated to the forward-direction and backward-direction memory areas. For example, such a proposal is described in Japanese Patent Laid-open No. 2006-91966.

According to Japanese Patent Laid-open No. 2006-91966, in one ring buffer memory management method, a write pointer and read pointer are constantly monitored, and each time the read pointer reaches the write pointer and a memory area in use is released, the boundary between the two memory areas is moved such that the capacity on the released side is made smaller. That is, for the read pointer to reach the write pointer means that there is no valid data in the buffer memory, and that data transfer processing is temporarily completed, so that the memory capacity on the side on which data transfer processing is completed is reduced, and the memory capacity on the side on which data transfer processing is pending is increased. As a result, memory capacities can be allocated to both memory areas according to the state of use.

However, in order to use both a read pointer and a write pointer to perform memory management of a ring buffer, during data transfer the read pointer must be updated each time data is read by one CPU and processing to release a newly usable memory area must be performed. Such processing to frequently release memory areas results in more frequency CPU interrupt processing, so that the overhead for data transfer processing by the CPU is increased, which is undesirable. Both CPUs perform their own processings in addition to data transfer, and execute data transfer processing in between their own processings. Hence increases in the overhead of data transfer processing for both CPUs reduces the efficiency of their own processing and data transfer processing.

### SUMMARY

It is an aspect of the embodiments discussed herein to provide a memory-sharing system device which shares common memory has: a shared memory, divided into a forward-direction memory area and a backward-direction memory area; a first processor, which input data for transfer in the forward direction from the lower-layer side and writes the data to the forward-direction memory area, and reads data for transfer in the backward direction from the backward-direction memory area and outputs the data to the lower-layer side; and a second processor, which input data for transfer in the backward direction from the upper-layer side and writes the data to the backward-direction memory area, and reads data for transfer in the forward direction from the forward-direction memory area and outputs the data to the upper-layer side, and the first or second processor sets memory release criteria for the forward-direction memory area and for the backward-direction memory area respectively, and, when the used memory area for which transfer data reading has been completed reaches the memory release criterion, performs memory release processing to release the used memory area for enabling writing; and the first or second processor monitors the forward-direction data transfer speed and the backward-direction data transfer speed, sets the memory release criterion for the forward-direction memory area or for the backward-direction memory area to a first memory release criterion when the corresponding transfer speed is a first transfer speed, and sets the memory release criterion to a second memory release criterion smaller than the first memory release criterion when the corresponding transfer speed is a second transfer speed higher than the first transfer speed.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows the configuration of a communication terminal device having a memory-sharing system device of a present embodiment;

FIG. 2 shows the configuration of a MAC unit;

FIG. 3 shows control of shared memory in the present embodiment;

FIG. 4 shows control of shared memory in the present embodiment;

FIG. 5 shows control of shared memory in the present embodiment;

FIG. 6 shows control of shared memory in the present embodiment;

FIG. 7 shows control of shared memory in the present embodiment;

FIG. 8 shows control of shared memory in the present embodiment;

FIG. 9 shows specific control of shared memory in the present embodiment;

FIG. 10 shows specific control of shared memory in the present embodiment;

FIG. 11 is a flowchart of specific control of shared memory in the present embodiment;

FIG. 12 shows an example of a table of data transmission speeds and corresponding memory release criteria in the present embodiment; and,

FIG. 13 shows control of memory release criteria in the present embodiment.

### DESCRIPTION OF THE PREFERRED EMBODIMENTS

Below, embodiments are explained referring to the drawings. However, the technical scope of an invention is not limited to these embodiments, but extends to the inventions described in the Scope of Claims, and to inventions equivalent thereto.

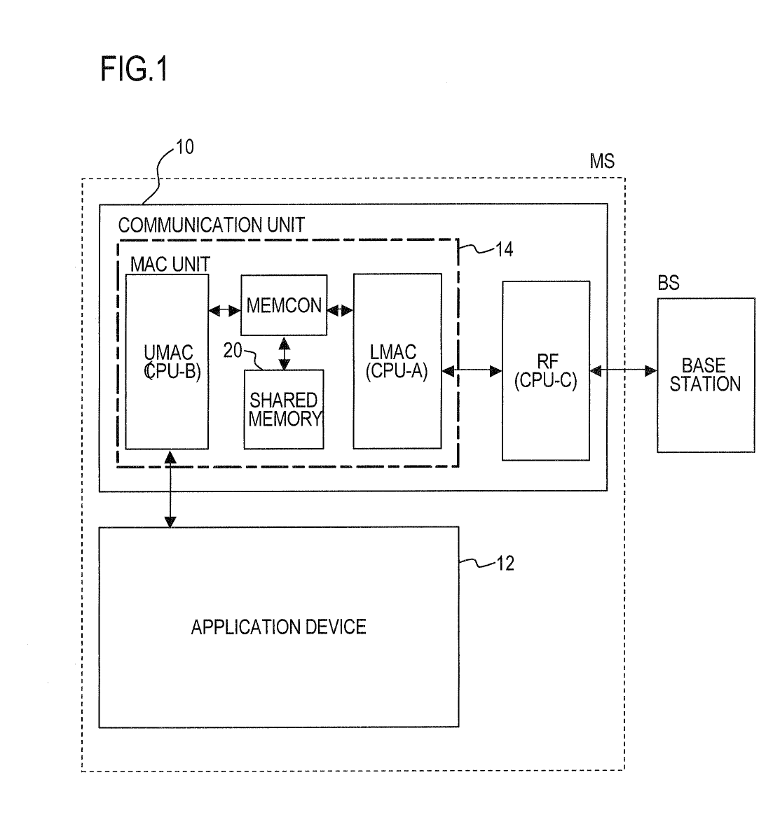

FIG. 1 shows the configuration of a communication terminal device having a memory-sharing system device, in a present embodiment. The mobile station MS and base station BS can be connected via wireless communication media. The mobile station MS has a communication unit 10, which transmits and receives data to and from the base station BS, provided at a lower level side on the wireless communication media, and an application device 12, which performs data downloading, data uploading, and other control in response to a upper-level user interface. The communication unit 10 has a MAC unit 14, which performs transfer of download data and upload data, and a wireless device RF which performs encoding, modulation, demodulation, and decoding.

The MAC unit 14 is one example of a memory-sharing system device. The MAC unit 14 has a lower-level processor LMAC (lower-level CPU-A), which takes reception data from the wireless device RF as input and outputs transmission data to the wireless device RF, and in addition controls peripheral hardware; an upper-level processor UMAC (upper-level CPU-B), which controls the protocol for communication with the base station, outputs reception data to the application device 12, and takes as input transmission data from the application device 12; a memory controller MEMCON; and shared memory 20.

When data is downloaded from the base station as the result of an instruction from the application device 12, the received data is transferred from the communication device RF to the upper-level application device 12, and within the MAC unit 14 data is transferred from the lower-level processor LMAC to the upper-level processor UMAC. This is defined as forward-direction data transfer. Conversely, when data is uploaded from the application device 12, the transmission data is transferred from the application device 12 to the communication device RF, and within the MAC unit 14 data is transferred from the upper-level processor UMAC to the lower-level processor LMAC. This is defined as backward-direction data transfer.

In the case of forward-direction data transfer, data transmitted from the base station BS is received by the wireless device RF, is demodulated and decoded, and is input to the MAC unit 14. The lower-level processor LMAC writes the input transfer data to the forward-direction memory area in the shared memory 20 via the memory controller MEMCON. The lower-level processor LMAC performs this writing of the transfer data independently of operation of the upper-level processor UMAC. On the other hand, the upper-level processor UMAC reads the written data from the forward-direction memory area via the memory controller MEMCON, and supplies the data to the application device 12. The memory area in which data has been written and read is released to a state in which writing is enabled by the lower-level or upper-level processor. Then, new transfer data is written to the released memory area.

In the case of backward-direction data transfer, the application device 12 outputs data to the upper-level processor UMAC, and the upper-level processor UMAC writes the data to the backward-direction memory area in the shared memory 20 via the memory controller. Then, the lower-level processor LMAC reads the written data from the backward-direction memory area via the memory controller MEMCON, and supplies the data to the wireless device RF. The wireless device RF encodes and modulates the transmission data and transmits the data to the base station BS. In the backward-direction memory area also, the used memory area from which data has been read is released so as to enable writing.

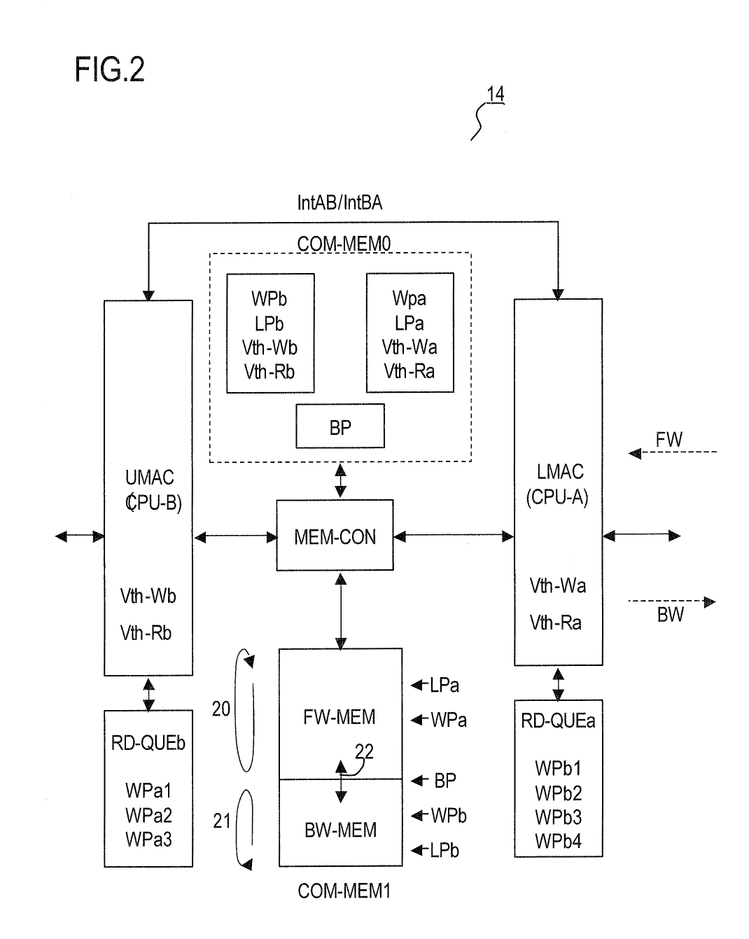

FIG. 2 shows the configuration of the MAC unit. As explained in FIG. 1, the MAC unit 14 has a lower-level processor LMAC and upper-level processor UMAC, shared memory COM-MEM shared by these processors, and a memory controller MEM-CON. The shared memory COM-MEM has a buffer area COM-MEM1 which temporarily stores data for transfer, and a shared memory area COM-MEM0 which stores various other data.

The buffer area COM-MEM1 is divided into a forward-direction memory area FW-MEM and a backward-direction memory area BW-MEM by a boundary pointer BP. In forward-direction data transfer in the direction of the arrow FW, the lower-level processor LMAC writes transfer data to the forward-direction memory area FW-MEM, and the upper-level processor UMAC reads this transfer data. Conversely, in backward-direction data transfer in the direction of the arrow BW, the upper-level processor UMAC writes transfer data to the backward-direction memory area BW-MEM, and the lower-level processor LMAC reads this transfer data.

Each of the memory areas FW-MEM and BW-MEM is used as a ring buffer; the forward-direction area FW-MEM is used with the address incremented sequentially as indicated by the arrow 20, and the backward-direction memory area BW-MEM is used with the address decremented sequentially as indicated by the arrow 21.

In order to use the memory areas as ring buffers, write pointers WPa, WPb indicating addresses at which data has been written, and release pointers LPa, LPb corresponding to addresses at which writing and reading have been completed, are managed for each of the memory areas FW-MEM and BW-MEM by both the processors LMAC and UMAC. Specifically, these pointers are stored within the shared memory area COM-MEM0.

Taking forward-direction data transfer as an example, the operation to transfer data between the processors is explained. As a premise, data writing and reading to and from shared memory by the two processors LMAC, UMAC is all performed via the memory controller MEM-CON. Access rights for the two processors to access shared memory are decided through arbitration by the memory controller MEM-CON.

First, the lower-level processor LMAC writes the transfer data to the next address after the write pointer WPa of the forward-direction memory area FW-MEM, and transmits an interrupt signal IntAB, together with the write pointer WPa1 for the written address, to the upper-level processor UMAC. The upper-level processor UMAC stores the write pointer WPa1 in a read queue matrix RD-QUEb. Data writing and reading of data in amounts determined in advanced is performed in memory blocks to corresponding addresses. Each time the lower-level processor LMAC writes data, the upper-level processor UMAC stores write pointers WPa1 to 3 in a read queue matrix RD-QUEb.

On the other hand, in between other processing, the upper-level processor UMAC accesses in order the addresses of the write pointers WPa1 to 3 in the read queue matrix RD-QUEb, reads the written transfer data, and supplies the data to the upper-level application device 12 (FIG. 1). And, when executing readout, the upper-level processor UMAC determines the areas in memory in which reading has been completed (and in which of course writing has been completed) from the release pointer LPa and the write pointers WPa1-3 corresponding to read addresses, and checks whether this has reached the memory release criterion Vth-Ra. If the criterion has been reached, the upper-level processor UMAC outputs an interrupt IntBA to the lower-level processor LMAC, and in response, the lower-level processor LMAC executes memory release processing as the interrupt processing. In memory release processing, the release pointer LPa is updated corresponding to the memory area for which reading has been completed. As a result, subsequent writing of data to the released memory area is permitted.

At the time of a read execution, the upper-level processor UMAC may check whether the memory area reading of which has been completed has reached the memory release criterion Vth-Ra, and also determine the memory area in which writing has been completed (regardless of whether reading has been completed) from the release pointer LPa and the write pointer WPa, and check whether this memory area has reached the other memory release criterion Vth-Wa. If both areas have reached to both criteria, the lower-level processor LMAC is notified of an interrupt, and is made to execute memory area release interrupt processing.

In ordinary data transfer, writing precedes reading, and so the memory area in which writing has been completed is larger than the memory area in which reading has been completed. Hence it is preferable that checks are made as to whether both memory release criteria Vth-Ra and Vth-Wa have been reached. That is, even when the memory area in which reading has been completed reaches the memory release criterion Vth-Ra, if the memory area in which writing has been completed has not reached the memory release criterion Vth-Wa, there is little need to release a memory area. Hence in order to reduce insofar as possible the frequency of memory release interrupt processing, it is desirable that checks be made as to whether both memory release criteria have been reached.

As explained above, the two processors LMAC and UMAC execute transfer data writing and reading respectively, and when the memory area in which reading has been completed and the memory area in which writing has been completed reach certain sizes, memory area release interrupt processing is executed. By reducing insofar as possible the frequency of memory release interrupt processing, the processing overhead for both processors can be decreased.

In backward-direction data transfer, similar operations are performed, except that the relations between the lower-level processor LMAC and the upper-level processor UMAC are reversed.

The buffer area COM-MEM1 is divided into a forward-direction memory area FW-MEM and a backward-direction memory area BW-MEM, with a boundary pointer BP as the boundary. In this embodiment, the boundary pointer BP between the two memory areas FW-MEM and BW-MEM is dynamically changed as indicated by the arrow 22 by one of the two processors LMAC and UMAC, according to the transmission speed of transfer data. That is, the processors LMAC and UMAC monitor transmission speeds in both directions, and dynamically modify the boundary pointer BP such that the size of the memory areas FW-MEM, BW-MEM corresponding to the transfer direction for which the transmission speed is higher is made larger. In other words, the ratio of sizes of the forward-direction memory area and backward-direction memory area is modified such that the size of the memory area corresponding to the higher transfer speed becomes larger, according to the two transfer speeds. As a result, a larger buffer area is allocated to the transfer direction with the higher transmission speed, and the data transfer efficiency can be increased.

Further, in this embodiment the memory release criteria Vth-Ra, Vth-Rb, Vth-Wa, Vth-Wb, which determine whether memory area release interrupt processing is performed, are modified dynamically according to the transfer data transmission speed. That is, the two processors LMAC and UMAC monitor the transmission speeds, and when a transmission speed rises, decrease memory release criteria, increasing the frequency with which release processing is performed for memory areas which have been used, and raising the buffer area utilization efficiency, and when a transmission speed falls, increase memory release criteria, decreasing the frequency of memory area interrupt processing, and so reducing the overhead due to interrupts.

Further, in this embodiment the memory release criteria Vth-Ra, Vth-Rb, Vth-Wa, Vth-Wb, which determine whether memory area release interrupt processing is performed, are dynamically modified according to the ratio of sizes of the forward-direction memory area and the backward-direction memory area. That is, the lower-level or upper-level processor LMAC or UMAC executes control to increase the memory release criteria for the forward-direction or backward-direction memory area when the size of the area increases. As a result, when through modification of the boundary pointer BP, the size of the forward-direction or backward-direction memory area is increased, the memory release criteria for the area are also increased, so that the memory release interrupt processing frequency is no longer kept higher than is necessary, but can be reduced to an appropriate processing frequency, so that overhead can be decreased.

Hence when the data transmission rate increases in either direction, the size ratio is modified such that the size of the corresponding memory area within the shared memory is increased. And, an increase in the data transmission rate is accompanied by reduction of the memory release criteria, so that the data transfer speed is increased. However, modification is performed such that if the size of the memory area is not large, the corresponding memory release criteria are made large, and consequently the memory release interrupt frequency is reduced.

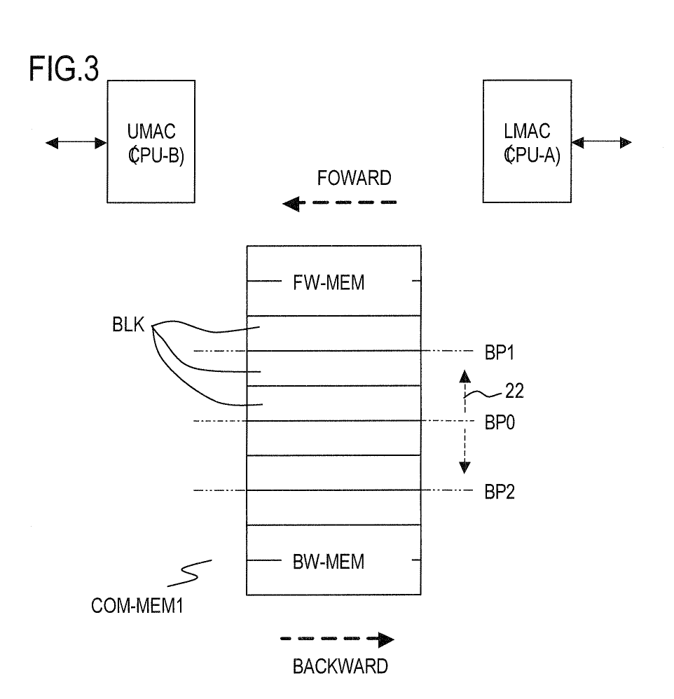

FIG. 3 illustrates control of shared memory in this embodiment. As shown in FIG. 2, the release pointers LPa, LPb used in write control for the buffer area COM-MEM1, the boundary pointer BP used in control of memory sizes, and the criteria Vth-Wa, Vth-Wb, Vth-Ra, Vth-Rb used to control the timing of memory release interrupt processing, and other data are stored in the shared memory area COM-MEM0. Transfer data writing and reading are performed in units of memory blocks BLK of a prescribed size.

As shown in FIG. 3, the lower-level processor LMAC or upper-level processor UMAC monitors the data transmission speeds in the forward and backward directions, and controls the ratio of sizes of the two memory areas such that the size of the forward-direction or backward-direction memory area, FW-MEM or BW-MEM, for which the data transmission speed is higher, is increased. Specifically, by modifying the boundary pointer BP, corresponding to the address of the boundary between the two memory areas, in the direction of the arrow 22, the ratio of sizes of the two memory areas is controlled. In the case of the boundary pointer BP0 in the figure, the ratio of sizes of the two memory areas is 50/50 (%); but in the case of the boundary pointer BP1 the ratio of the size of the backward-direction memory area BW-MEM is larger, and in the case of the boundary pointer BP2 the ratio of the size of the forward-direction memory area FW-MEM is larger.

Monitoring of the data transmission speed is performed by monitoring, per unit time, the amount of transfer data written to the buffer area COM-MEM1 in the shared memory by one processor and the amount of data reading of which is completed by the other processor.

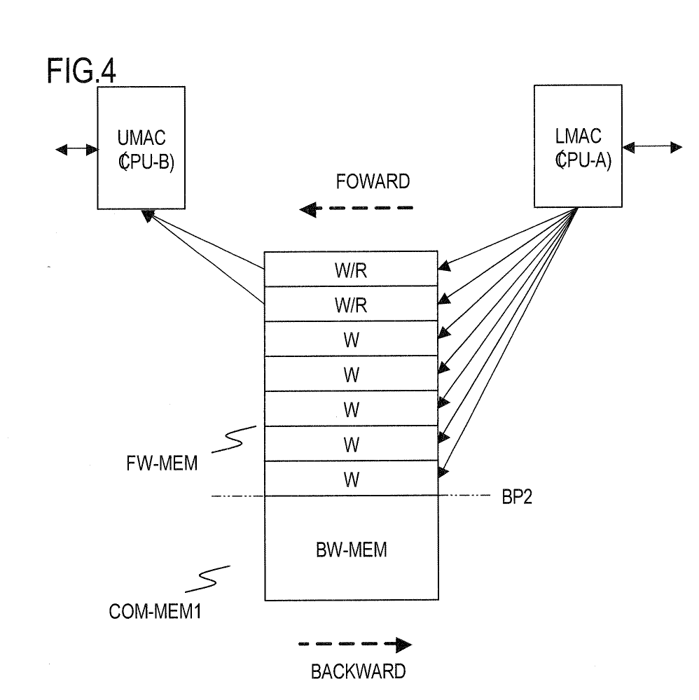

FIG. 4 illustrates control of shared memory in this embodiment. As explained in FIG. 3, control is executed such that the size ratio is increased for the memory area on the side for which the greater amount of data is transferred; but as shown in FIG. 4, even when the boundary pointer BP2 is modified to a higher address value and the size ratio of the forward-direction memory area FW-MEM is increased, the ratio of the data transfer processing abilities of the lower-level processor LMAC writing the transfer data and the upper-level processor UMAC reading the transfer data is not necessarily held constant. This also arises from differences in the processing abilities of the two processors, and even when the processing abilities are the same, when the amount of processing of one is greater, the data transfer processing ability is reduced.

In the example of FIG. 4, the data transfer processing ability of the lower-level processor LMAC is high, and transfer data is written to all the blocks within the forward-direction memory area FW-MEM (in the figure, “W” indicates that writing has been performed). However, the data transfer processing ability of the upper-level processor UMAC is low, and reading has been completed in only a portion of the memory blocks to which writing has been completed (in the figure, “R” indicates that reading has been performed). Under these circumstances, merely performing control to change the boundary pointer BP and control the ratio of sizes of the two memory areas will not increase the efficiency of data transfer.

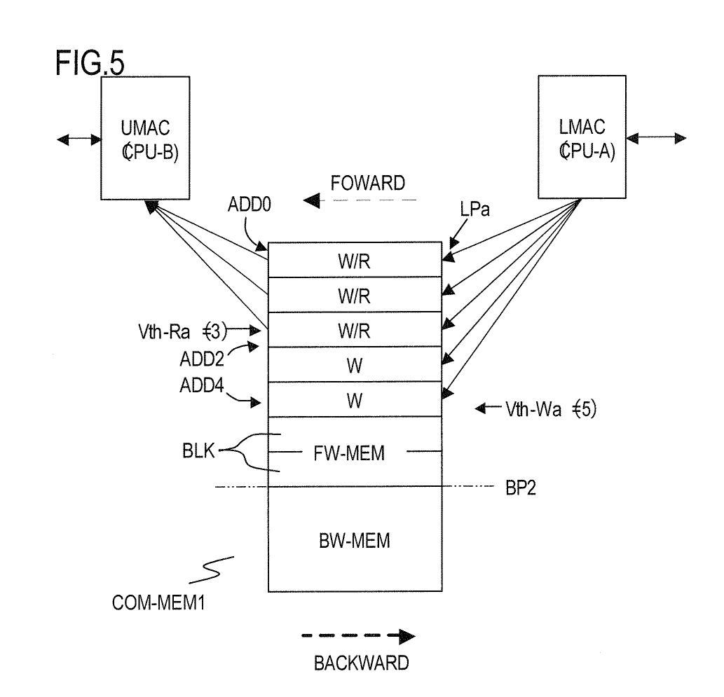

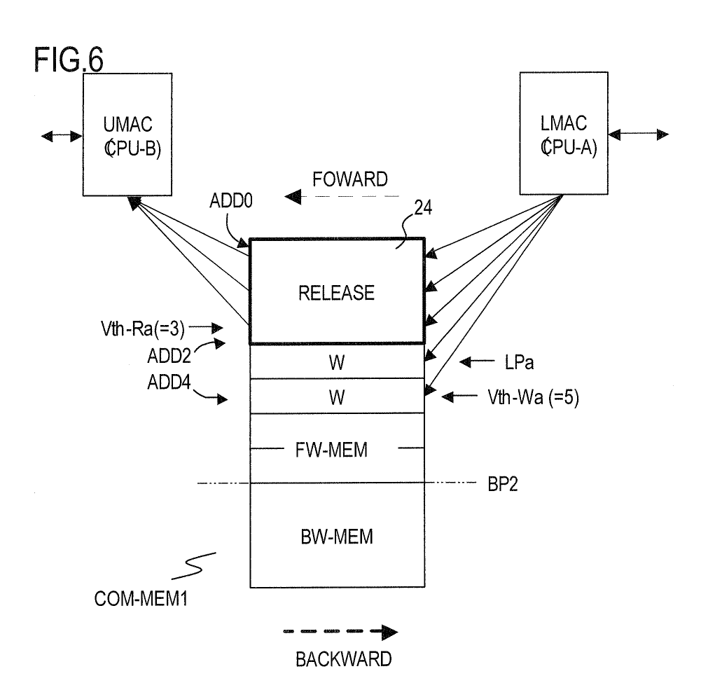

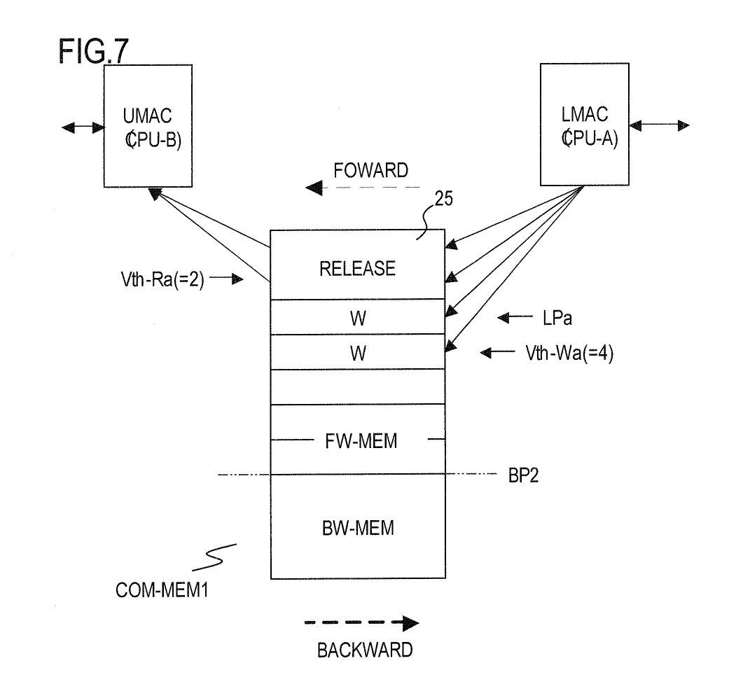

FIG. 5, FIG. 6, and FIG. 7 are diagrams illustrating control of shared memory in this embodiment. Forward-direction data transfer is explained, tentatively assuming that transfer data is written in order in the forward-direction memory area FW-MEM from address ADD0 to address ADD4 (indicated in the figure by “R/W” and “W”), and that reading is completed of only the first 3 blocks, from address ADD0 to address ADD2 (“W/R” in the figure).

The processors LMAC and UMAC set the write criterion Vth-Wa and read criterion Vth-Ra, as memory release criteria which control the timing of memory release interrupt processing, and check whether the reading-completed area (the “R/W” area in the figure) has reached the read criterion Vth-Ra and whether the writing-completed area (the “R/W” and “W” areas in the figure) has reached the write criterion Vth-Wa. When the reading-completed memory area R/W has reached the read criterion Vth-Ra, or the reading-completed memory area R/W has reached the read criterion Vth-Ra and moreover the writing-completed memory area has reached the write criterion Vth-Wa, memory release processing is performed to read the release pointer LPa indicating the used memory area and change the pointer to the address of the next memory block after the reading-completed memory area R/W.

In the example of FIG. 5, the read criterion Vth-Ra is set to 3 blocks, and the write criterion Vth-Wa is set to 5 blocks; 3 blocks from the release pointer LPa has been read (W/R), and 5 blocks has been written (W). Hence both criteria have been reached. As a result, as shown in FIG. 6, the release pointer LPa is modified to the next memory block address after ADD2, and the first 3 blocks 24 are released and can again be written.

In this way, at the time that the size of the reading-completed area reaches a certain size, or at the time that the reading-completed memory area reaches a certain size and moreover the writing-completed memory area also reaches a certain size, memory release interrupt processing is performed, so that the frequency of memory release interrupt processing can be reduced. In particular, by checking whether both the reading-completed memory area and the writing-completed memory area have reached the respective criteria, memory release interrupt processing can be made to be performed at the optimum frequency based on the data transfer abilities of both processors.

In FIG. 7, a case is shown in which the data transmission speed for forward-direction data transfer is greater than in FIG. 5 and FIG. 6; since the data transmission speed (the amount of transfer data per unit time for which both writing and reading have been completed) is higher, the memory release criteria Vth-Ra, Vth-Wa are controlled to be smaller. That is, the settings are changed such that the read criterion Vth-Wa is 2 blocks and the write criterion Vth-Wa is 4 blocks, and when both these criteria have been reached, the memory area 25 of the first 2 blocks is released.

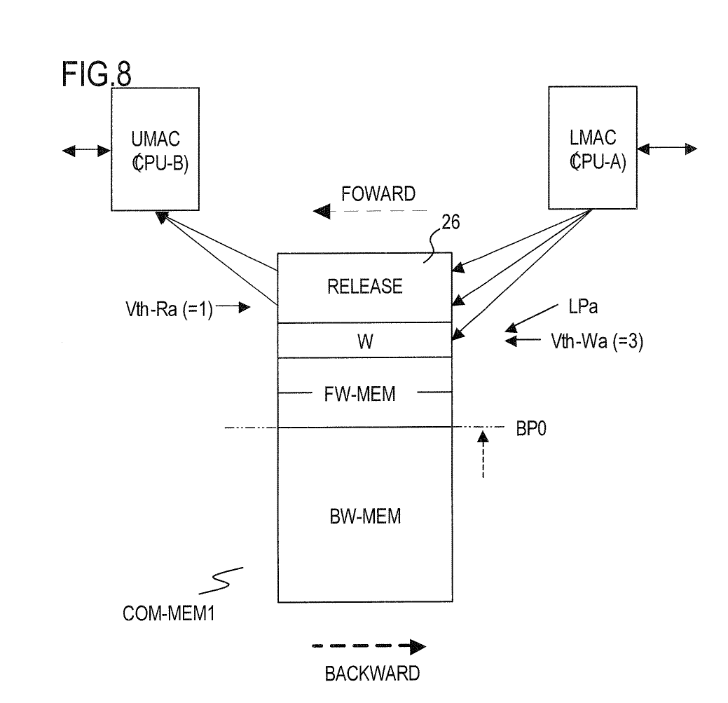

FIG. 8 illustrates control of the shared memory in this embodiment. In FIG. 8, compared with the state of FIG. 7, the boundary pointer BP0 is modified such that the size of the forward-direction memory area FW-MEM is reduced. The size ratio of the forward-direction memory area FW-MEM is small, so that the memory release criteria Vth-Wa, Vth-Ra are set to have smaller values, with Vth-Wa=3 blocks and Vth-Ra=1 block. As a result, the frequency of memory release interrupt processing is higher, and the usage efficiency of a buffer area of small size is increased.

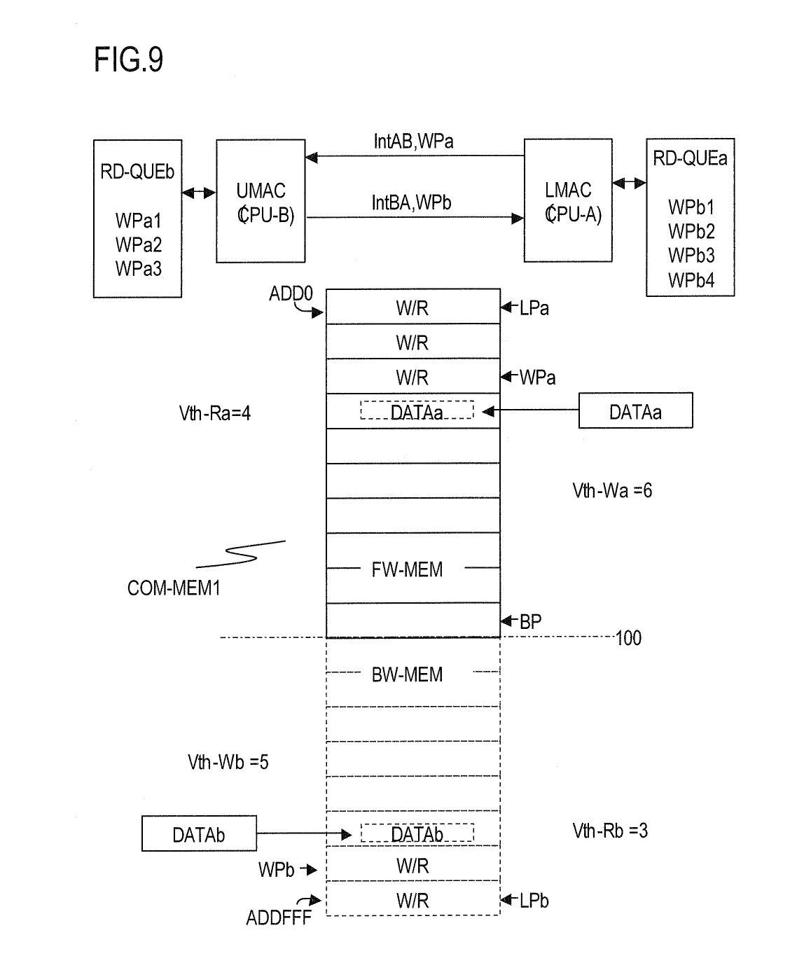

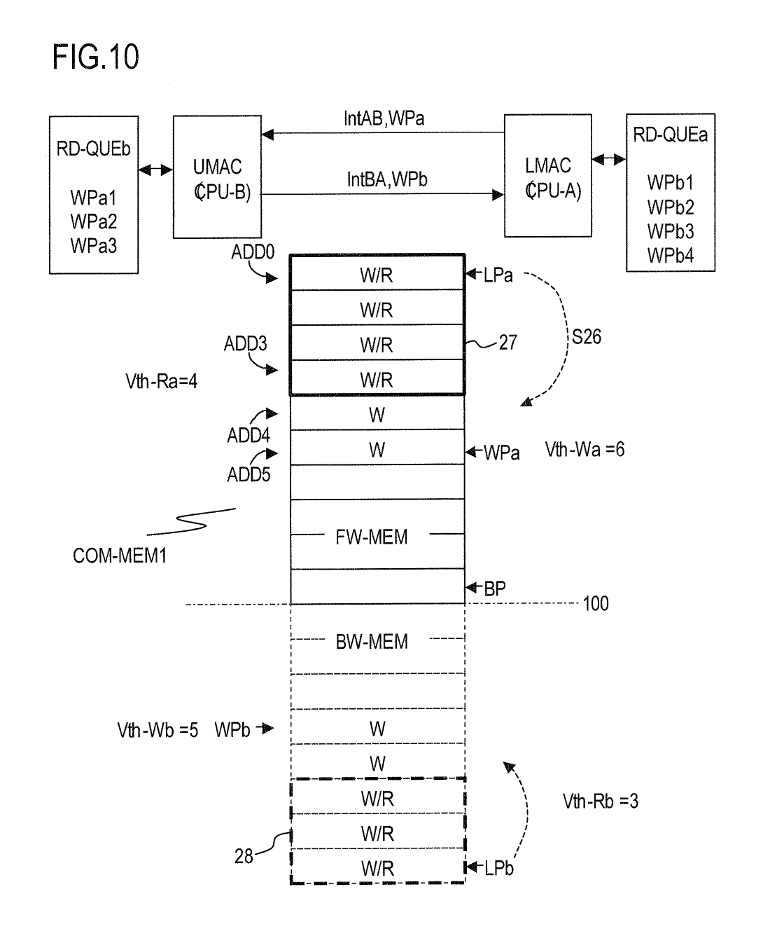

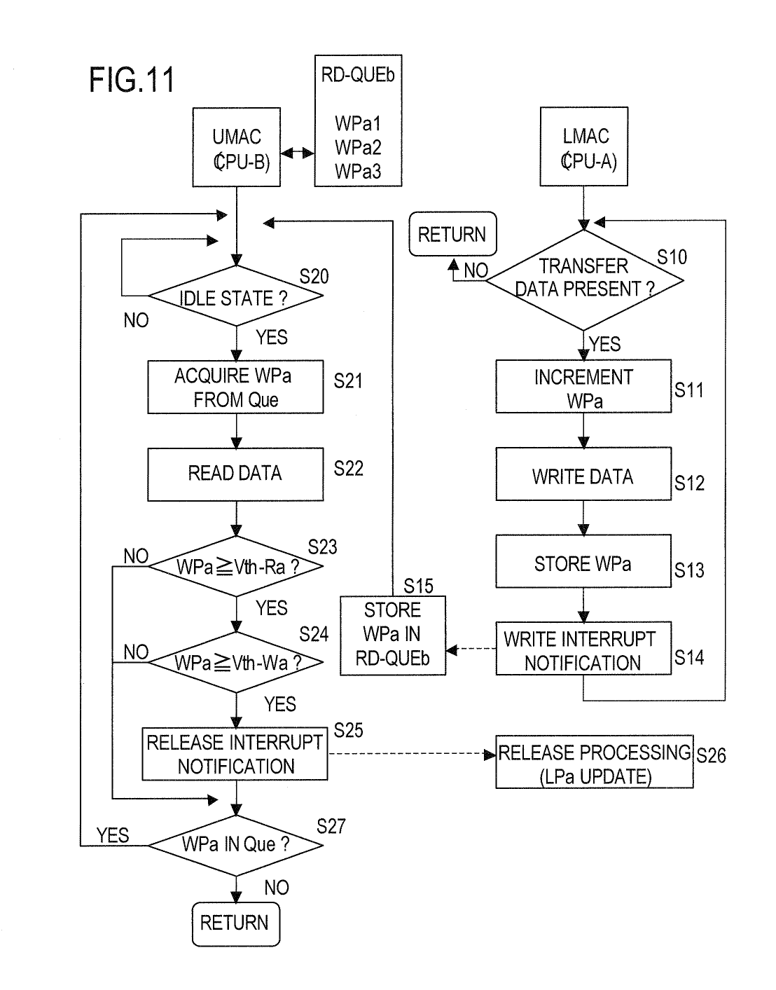

FIG. 9 and FIG. 10 illustrate specific control of the shared memory in this embodiment. FIG. 11 is a flowchart of specific control of the shared memory in this embodiment. The specific control of shared memory is explained following the flowchart of FIG. 11, referring to FIG. 9 and FIG. 10.

In the state of FIG. 9, the boundary 100 is set such that the size ratio between the forward-direction memory area FW-MEM and the backward-direction memory area BW-MEM is 10:8. The boundary pointer BP is set to the uppermost address of the forward-direction memory area FW-MEM corresponding to this boundary 100. For the forward-direction memory area FW-MEM, the memory release criteria are set to Vth-Ra=4 blocks and Vth-Wa=5 blocks, and for the backward-direction memory area BW-MEM, the memory release criteria are set to Vth-Rb=3 blocks and Vth-Wb=4 blocks. The write pointers WPa, WPb are managed corresponding to the respective writing-completed areas, and the release pointers LPa, LPb are managed corresponding to the memory release areas.

As shown in FIG. 11, when transfer data is present (YES in S10), the lower-level processor LMAC reads the write pointer WPa within the shared memory area COM-MEM0, and writes transfer data of a prescribed size to the memory block with the address resulting by incrementing the write pointer address (S11, S12). Then, the lower-level processor LMAC stores the address of the write memory block, as the new write pointer WPa, to the shared memory area COM-MEM0 (S13), and outputs a write interrupt notification IntAB, together with the new write pointer WPa, to the upper-level processor UMAC (S14). The above write processing S11 to S14 is repeated by the lower-level processor LMAC so long as there exists transfer data (YES in S10).

Each time a write interrupt notification IntAB is received from the lower-level processor LMAC, the upper-level processor UMAC stores the appended write pointers WPa1-3 in the read gueie matrix RD-QUEb (S15). Then, in an idle state between other processing (YES in S20), the upper-level processor UMAC reads the write pointer WPa from the read queue matrix RD-QUEb, reads the transfer data from the forward-direction memory area, and supplies this data to the upper-level application device (S22).

Then, after reading, the upper-level processor UMAC checks whether the writing-completed memory area (3 blocks) determined from the release pointer RPa and the write pointer WPa corresponding to the read address has reached the read criterion Vth-Ra (=4) (S23). If the read criterion has been reached, the upper-level processor UMAC further checks whether the write-completed memory area (3 blocks) determined from the release pointer RPa and the most recent write pointer WPa stored in the shared memory area COM-MEMO has reached the write criterion Vth-Wa (=6) (S24). If neither condition is satisfied (NO in S23 or S24), the upper-level processor UMAC does not send memory release interrupt notification (S25), but repeats the above read processing S21 to S24 so long as the write pointer WPa exists in the read queue matrix RD-QUEb (YES in S27).

In FIG. 9, the read criterion Vth-Ra=4 has not been reached, nor has the write criterion Vth-Wa=6 been reached, so that memory release interrupt processing is not performed. Similarly in the backward-direction memory area BW-MEM also, the read criterion Vth-Rb=3 has not been reached, nor has the write criterion Vth-Wb=5 been reached, so that memory release interrupt processing is not performed.

In FIG. 10, in the forward-direction memory area FW-MEM, data writing up to address ADD5 has been completed and data reading up to address ADD3 has been completed. Hence when reading of address ADD3 has been performed, the upper-level processor UMAC detects that the reading-completed memory area (4 blocks) has reached the read criterion Vth-Ra=4 (YES in S23), and that the writing-completed memory area (6 blocks) has reached the write criterion Vth-Wa=6 (YES in S24). Accompanying this, the upper-level processor UMAC outputs a memory release interrupt notification IntBA to the lower-level processor LMAC (S25). In response, the lower-level processor LMAC executes memory release processing to modify the release pointer LPa from address ADD0 to address ADD4, and to store the result in the shared memory area COM-MEM0 (S26). By this means, the lower-level processor LMAC can ascertain that writing is newly possible in the four-block memory area 27 from address ADD0 to address ADD3.

The backward-direction data transfer processing flowchart is the same as in FIG. 11, but with the relations of the lower-level processor LMAC and upper-level processor UMAC reversed. In FIG. 10, in the backward-direction memory area BW-MEM also, the reading-completed memory area (3 blocks) has reached the read criterion Vth-Rb=3, and the writing-completed memory area (5 blocks) has also reached the write criterion Vth-Wb=5, so that the release pointer LPb is modified and the three-block memory area 28 is released.

As explained above, in this embodiment, memory release interrupt processing is not performed to reading-completed memory areas, that is, usage-completed memory areas, each time both processes have read data. The memory release interrupt processing is performed when the reading-completed memory area has reached a criterion Vth-Ra, and preferably when the writing-completed memory area has also reached a criterion Vth-Wa. Hence the frequency of memory release interrupt processing can be reduced.

In this embodiment, the criteria Vth-Ra, Vth-Wa, Vth-Rb, Vth-Wb, which are criteria used to decide the timing of the above memory release interrupt processing, are modified and set according to the respective data transmission speeds. Specifically, dynamic control is executed to reduce the criteria Vth-Ra, Vth-Wa or Vth-Rb, Vth-Wb of the forward-direction or backward-direction memory area FW-MEM or BW-MEM the data transmission speed of which is greater. Hence the lower-level processor LMAC monitors the forward-direction data transmission speed, and dynamically controls the criteria Vth-Ra and Vth-Wa for the forward-direction memory area FW-MEM. And, the upper-level processor UMAC monitors the backward-direction data transmission speed and dynamically controls the criteria Vth-Rb and Vth-Wb for the backward-direction memory area BW-MEM.

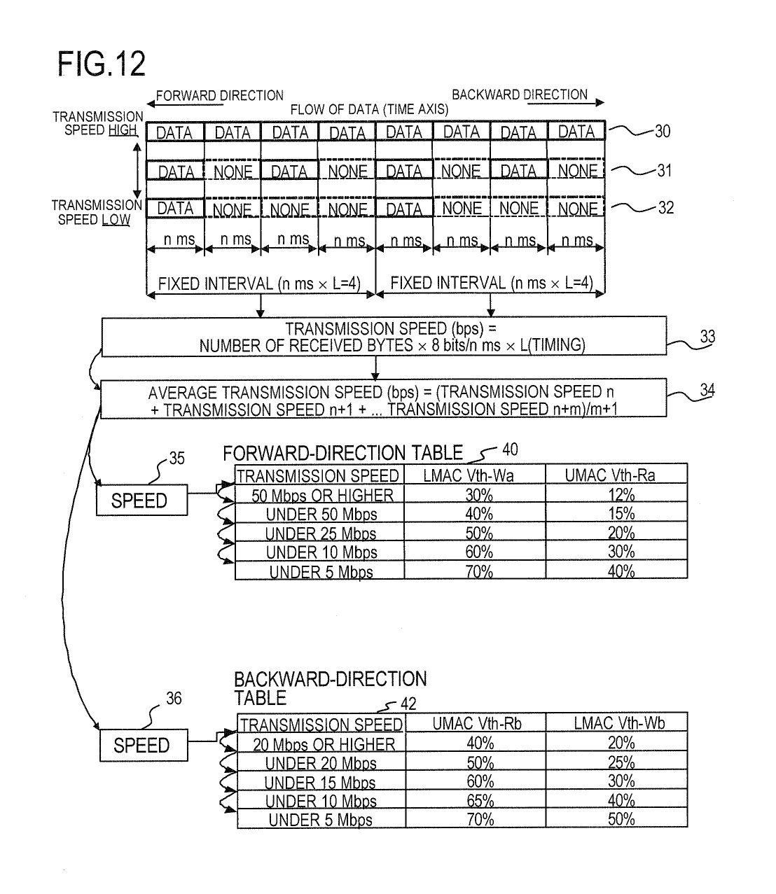

FIG. 12 shows an example of a table of memory release criteria corresponding to data transmission speeds in this embodiment. In FIG. 12, the horizontal axis indicates time and data transmission examples 30, 31, 32 are shown. In wireless communication, one frame of data is transmitted in a unit of time (n msec). A plurality of packets are comprised in one data transmission frame, and corresponding to this, data is written to and read from a plurality of memory blocks in the buffer area COM-MEM1.

In data transmission example 30 data is transmitted in all frame intervals, and the transmission speed is high. On the other hand, in data transmission example 31, data is transmitted in approximately 50% of frame intervals, and the transmission speed is somewhat low. And in data transmission example 32, data is transmitted in only approximately 25% of frame intervals, and the transmission speed is low.

Both processors LMAC and UMAC monitor the amount of data transmitted in a prescribed number L of frame intervals, such as for example L=4. That is, as indicated by the transmission speed calculation formula 33, the number of data bytes received and transmitted over the period of L=4 frame intervals is multiplied by 8 bits, divided by the time of the L frame intervals (n msec×L), and taken to be the transmission speed (bps). Then, the two processors LMAC and UMAC determine the average of the transmission speed over a plurality of L frame intervals, as indicated by the transmission speed calculation formula 34. It is preferable that the forward-direction data transmission speed be monitored by the lower-level processor LMAC which receives data, and that the backward-direction data transmission speed be monitored by the upper-level processor UMAC which receives data.

The above data transmission speeds can be determined from the transfer data amounts received by the two processors LMAC and UMAC. That is, the transfer data amounts written to the buffer areas in shared memory are used. Or, the transfer data amounts received by the two processors, written to buffer areas, and read from buffer areas may be used. In either case, based on a change of the write pointer WP stored in the shared memory area COM-MEM0 used in buffer area memory management and a change of the write pointer WP in the read queue matrix, the data amount per unit time can be monitored.

FIG. 12 shows the forward-direction table 40 and backward-direction table 42. The lower-level processor LMAC monitors the forward-direction data transmission speed, and sets the criteria Vth-Wa and Vth-Ra corresponding to the detected transmission speed in the forward-direction table 40. The upper-level processor UMAC monitors the backward-direction data transmission speed, and sets the criteria Vth-Wb and Vth-Rb corresponding to the detected data transmission speed in the backward-direction table 42. The criteria values (%) in each of the tables are the ratio to the sizes of the corresponding memory areas FW-MEM and BW-MEM.

Thus in this embodiment, the higher the transmission speed, the smaller the criteria values are set, so that at higher transmission speeds memory is released frequently and the efficiency of buffer area use is increased; and the lower the transmission speed, the higher the criteria values are set, so that at low transmission speeds the frequency of memory release processing is reduced, and unnecessary overhead is decreased.

Further, in WiMAX and other wireless communication methods, generally the amount of data downloaded, corresponding to forward-direction data transmission, is greater than the amount of data uploaded, corresponding to backward-direction data transmission. Hence in the tables 40 and 42 in FIG. 12, the group of transmission speeds in the forward-direction table 40 are higher than the group of transmission speeds in the backward-direction table 42. Also, for the same transmission speed, the criteria values are lower in the forward-direction table 40.

In the flowchart of FIG. 11, the processor LMAC which receives transfer data performs processing to monitor the data transfer speed and modify memory release criteria in parallel with the write processing S11 to S14.

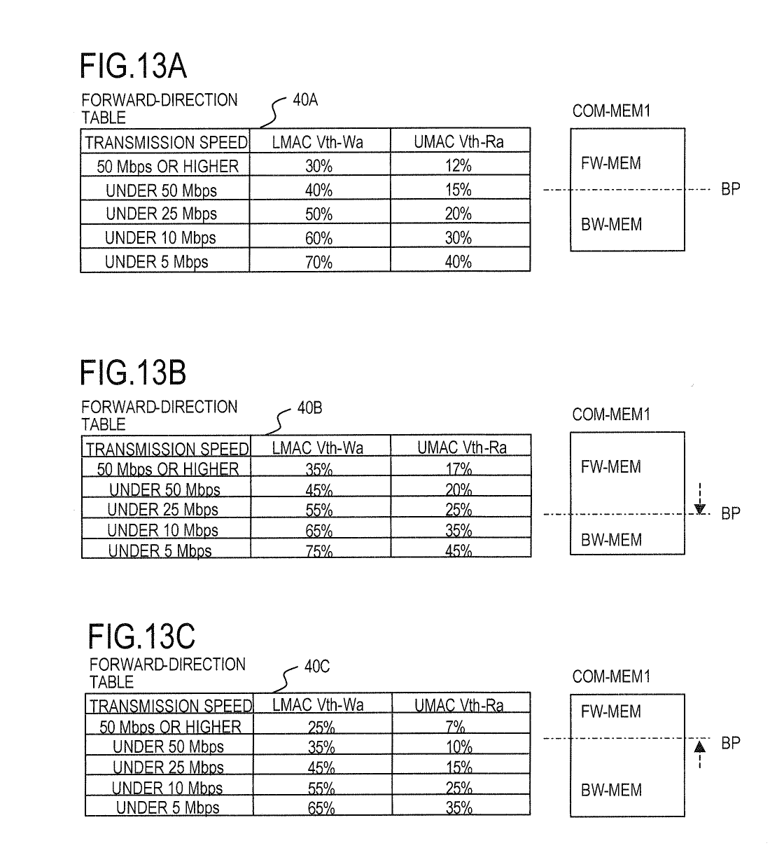

FIG. 13 illustrates control of memory release criteria in this embodiment. In FIG. 13, only examples of forward-direction tables are shown. The table 40A is for a case in which the size ratio of the forward-direction memory area FW-MEM and backward-direction memory area BW-MEM in the buffer area COM-MEM1 is 50:50%, and the criteria are the same as in the forward-direction table 40 of FIG. 12.

On the other hand, the table 40B is for a case in which the size ratio of the forward-direction memory area FW-MEM and backward-direction memory area BW-MEM is 70:30%. Because the fraction of the forward-direction memory area is larger, the memory release criteria Vth-Ra and Vth-Wa are larger than in the table 40A. This is because the larger buffer area results in a lower frequency of memory release interrupt processing, so that overhead is decreased, and the overall data transfer efficiency can be improved.

Conversely, table 40C is for a case in which the size ratio of the forward-direction memory area FW-MEM and backward-direction memory area BW-MEM is 30:70%. For example, when uploading is frequently performed, the boundary pointer BP may be set so that such a size ratio results. Because the fraction of the forward-direction memory area is smaller, the memory release criteria Vth-Ra and Vth-Wa are smaller than in table 40A. Due to the smaller buffer area, the memory release criteria is decreased and the memory release processing frequency is raised, so that the memory area in which writing is possible is increased, and the overall data transmission efficiency can be improved.

As explained above, the two processors LMAC and UMAC control the size ratio of memory areas according to the transmission speeds in the respective directions, and reference the criteria tables 40A, 40B, 40C corresponding to the size ratio to dynamically modify and set memory release criteria corresponding to the transmission speeds. In order to prevent conflict between first control, in which the memory release criteria are lowered (or raised) based on the tables of FIG. 12 when the data transmission speed rises (or falls), and second control, in which the size ratio of memory areas is changed and the memory release criteria are raised (or lowered) based on the tables of FIG. 13 when the data transmission speed rises (or falls), it is desirable that the frequencies of occurrence of the two control types be made different. For example, the first control frequency may be set to be higher than the second control frequency.

As explained above, by means of at least one embodiment, when two processors share memory which is used as buffer areas for forward-direction and backward-direction data transfer, by dynamically changing optimal memory release criteria according to transmission speeds, the frequency of memory release interrupt processing can be optimized. The two processors need not perform the memory area release interrupt processing each time data writing to or data reading from a buffer area is performed, so that the overhead associated with memory release interrupts can be reduced, and data transfer efficiency can be improved.

What is claimed is:

1. A memory-sharing system device which shares common memory, comprising:
a shared memory, divided into a forward-direction memory area and a backward-direction memory area;
a first processor, which input data for transfer in a forward direction from a lower-layer side and writes the data to the forward-direction memory area, and reads data for transfer in a backward direction from the backward-direction memory area and outputs the data to the lower-layer side; and
a second processor, which input data for transfer in the backward direction from an upper-layer side and writes the data to the backward-direction memory area, and reads data for transfer in the forward direction from the forward-direction memory area and outputs the data to the upper-layer side, wherein
the first or second processor sets memory release criteria for the forward-direction memory area and for the backward-direction memory area respectively, and, when the used memory area for which the transfer data reading has been completed reaches the memory release criteria, performs memory release processing to release the used memory area for enabling writing; and
the first or second processor monitors a forward-direction data transfer speed and a backward-direction data transfer speed, sets the memory release criterion for the forward-direction memory area or for the backward-direction memory area to a first memory release criterion when the corresponding transfer speed is a first transfer speed, and sets the memory release criterion to a second memory release criterion smaller than the first memory release criterion when the corresponding transfer speed is a second transfer speed higher than the first transfer speed.

2. The memory-sharing system device according to claim 1, wherein
the memory release criteria comprises a read criterion corresponding to the area in which reading is completed and a write criterion corresponding to the area in which writing is completed, and
the first or second processor performs the memory release processing when the used memory area reaches the read criterion and the memory area in which writing is completed reaches the write criterion.

3. The memory-sharing system device according to claim 1, wherein
the first and second processors perform, in units of memory block areas having prescribed size, transfer data writing and reading;
when the first or second processors writes transfer data to a corresponding memory area, the first or second processor supplies the write address as well as a write interrupt notification to the second or first processor;
upon receiving the write interrupt notification, the second or first processor stores the write address in read queue matrix memory, and thereafter, when reading the transfer data at the write address stored in the read queue matrix memory, if the used memory area has reached the memory release criterion, issues a release interrupt notification to the first or second processor; and
upon receiving the release interrupt notification, the first or second processor performs the release processing for the used memory area.

4. The memory-sharing system device according to claim 3, wherein the first and second processors manage release pointers respectively indicating addresses of released memory areas in the forward-direction and backward-direction memory areas, and update the release pointers according to the used memory areas in the release processing.

5. The memory-sharing system device according to claim 4, wherein the first and second processors determine sizes of the memory areas in which writing is completed from the release pointers and the latest write address in the forward-direction and backward-direction memory areas, and determine sizes of the used memory areas in which reading is completed from the release pointers and the write addresses at the time of reading.

6. The memory-sharing system device according to claim 1, wherein
the first processor monitors the transmission speed of data transferred in the forward direction and variably controls the memory release criterion of the forward-direction memory area according to the monitored transmission speed, and
the second processor monitors the transmission speed of data transferred in the backward direction and variably controls the memory release criterion of the backward-direction memory area according to the monitored transmission speed.

7. A memory-sharing system device which shares common memory, comprising:
a shared memory, divided into a forward-direction memory area and a backward-direction memory area;
a first processor, which input data for transfer in a forward direction from a lower-layer side and writes the data to the forward-direction memory area, and reads data for transfer in a backward direction from the backward-direction memory area and outputs the data to the lower-layer side; and
a second processor, which input data for transfer in the backward direction from an upper-layer side and writes the data to the backward-direction memory area, and reads data for transfer in the forward direction from the forward-direction memory area and outputs the data to the upper-layer side, wherein
the first or second processor monitors a forward-direction data transfer speed and a backward-direction data transfer speed, and modifies a size ratio of the forward-direction memory area and backward-direction memory area, according to both of the transfer speeds, such that the size of the memory area corresponding to the higher transfer speed is greater.

8. The memory-sharing system device according to claim 7, wherein
the first or second processor sets memory release criteria for the forward-direction memory area and backward-direction memory area respectively, and when the used memory area in which reading of the transfer data has been completed reaches the memory release criterion, performs memory release processing to release the used memory area for enabling writing; and
the first or second processor sets the memory release criteria for the forward-direction memory area and backward-direction memory area to a first memory release criterion when the corresponding transfer speed is a first transfer speed, and to a second memory release criterion which is smaller than the first memory release criterion when the corresponding transfer speed is a second transfer speed which is greater than the first transfer speed.

9. The memory-sharing system device according to claim 8, wherein the first or second processor sets the memory release criteria for the forward-direction memory area and backward-direction memory area to a third memory release criterion when the memory area is of a first size and to a fourth memory release criterion, which is larger than the third memory release criterion, when the memory area is of a second size larger than the first size.

10. The memory-sharing system device according to claim 8, wherein
the memory release criteria includes a read criterion corresponding to the area in which reading is completed and a write criterion corresponding to the area in which writing is completed, and
the first or second processor performs the memory release processing when the used memory area reaches the read criterion and the memory area in which writing is completed reaches the write criterion.

11. A communication terminal device, comprising:
the memory-sharing system device according to any of claims 1 through 10;
a communication device, which outputs data for transfer in the forward direction to the first processor and takes input of data for transfer in the backward direction from the first processor; and
an application device, which takes input of data for transfer in the forward direction from the second processor, and outputs data for transfer in the backward direction to the second processor.
